(19) United States
(12) Patent Application Publication
(10) Pub. No.: US 2002/0169942 A1
(43) Pub. Date: Nov. 14, 2002

(54) VLIW processor

(76) Inventor: Hideki Sugimoto, Tokyo (JP)

Correspondence Address: McGinn & Gibb, PLLC, Suite 200, 8321 Old Courthouse Road, Vienna, VA, 22182-3817, US

(21) Appl. No.: 10/137,358

(22) Filed: May 3, 2002

(30) Foreign Application Priority Data
May 8, 2001 (JP) 137439/2001

(51) Int. Cl. G06F 15/00

(52) U.S. Cl. 712/24

(57) ABSTRACT

The VLIW processor according to the present invention, which executes in parallel a plurality of processings described in parallel in a VLIW instruction using a plurality of execution pipelines, performs pipeline execution of processings selected and designated from among the plurality of processings based on the VLIW instruction in respective steps on a diagonal formed by shifting one step at a time starting with an initial step in the order of parallel arrangement of the plurality of execution pipelines, one by one in the direction of the diagonal.

### BACKGROUND OF THE INVENTION

1. Field of the Invention

The present invention relates to a very long instruction word (VLIW) processor, and more particularly to a VLIW processor which executes a plurality of processings described in parallel in an instruction of very long instruction word (referred to as VLIW instruction hereinafter) using a plurality of execution pipelines.

2. Description of the Prior Art

Conventionally, a VLIW processor executes in parallel a plurality of processings described in parallel in a VLIW instruction using a plurality of execution pipelines by fetching and decoding the VLIW instruction.

For example, in FIG. 5 which is a block diagram showing schematically an execution part and its circumference of a conventional VLIW processor, an instruction register 11 and a register file 21 which fetches and decodes a VLIW instruction are provided in an instruction fetch part and an instruction decode part, respectively, and four execution pipelines 31 to 34 which execute four processings described in parallel in the VLIW instruction are provided as an execution part.

In the figure, reg1, reg2, opr indicated in the instruction register 11 represent operand code 1, operand code 2 and operation code, respectively, of the four processings described in parallel in the VLIW instruction, and abbreviation PR as a block name represents a pipeline register. Pipelines other than the four execution pipelines 31 to 34, and other control parts are omitted from the figure.

The execution pipeline 31 is equipped with a load processing unit which inputs operands accessed from the register file 21 based on the operand codes of the VLIW instruction fetched by the instruction register 11 and executes load processing LD based on the operation code of the VLIW instruction, and a pipeline register which transfers in pipeline the output of the processing unit and outputs the execution result.

The execution pipeline 32 is equipped with a multiplication processing unit which inputs operands accessed from the register file 21 based on the operand codes of the VLIW instruction fetched by the instruction register 11 and executes multiplication processing MUL based on the operation code of the VLIW instruction, and a pipeline register which transfers in pipeline the output of the processing unit and outputs the execution result.

The execution pipeline 33 is equipped with an integer processing unit 1 which inputs operands accessed from the register file 21 based on the operand codes of the VLIW instruction fetched by the instruction register 11 and executes integer processing INT 1 based on the operation code of the VLIW instruction, and a pipeline register which transfers in pipeline the output of the processing unit and outputs the execution result. Moreover, the execution pipeline 34 is equipped with an integer processing unit 2 which inputs operands accessed from the register file 21 based on the operand codes of the VLIW instruction fetched by the instruction register 11 and executes integer processing INT 2 based on the operation code of the VLIW instruction, and a pipeline register which transfers in pipeline the output of the processing unit and outputs the execution result.

FIG. 6 is a timing chart showing the pipeline operation of the conventional VLIW processor in which the VLIW instructions in the program execution order, and the execution pipelines and the clock cycles are shown in the vertical and horizontal directions, respectively, and instruction fetch IF, instruction decoding ID, load processing LD, multiplication processing MUL, integer processing INT 1, integer processing INT 2 and write back WB that are processings in respective pipeline steps of the VLIW instruction are displayed two-dimensionally.

Next, referring to FIG. 6, the pipeline operation of the conventional VLIW processor will be described briefly.

First, VLIW instruction 1 is fetched and decoded in clock cycles T1 and T2, respectively operands are accessed respectively from the register file 21 based on the operand codes of the VLIW instruction 1, the load processing LD described in parallel in the VLIW instruction 1 is executed in the pipeline 31 in clock cycles T3 and T4, and the write back WB of the execution results is carried out in clock cycle T5. Moreover, in the other three execution pipelines 32 to 34, the multiplication processing MUL, the integer processing INT 1 and the integer processing INT 2 that are described in parallel in the VLIW instruction 1 are executed in parallel in clock cycle T3, and the write back WB of the respective processing results is carried out in clock cycle T4.

Similarly, VLIW instruction 2 which is in the next program execution order is fetched and decoded in clock cycles T2 and T3, respectively, operands are accessed respectively from the file register 21 based on the operand codes of the VLIW instruction, and since the load processing LD described in parallel in the VLIW instruction 1 is under execution in the execution pipeline 31 in clock cycle T4, the load processing LD described in parallel in the VLIW instruction 2 will not be executed. Besides, the multiplication processing MUL, the integer processing INT 1 and the integer processing INT 2 described in parallel in the VLIW instruction 2 are executed in parallel in the other three execution pipelines in clock cycle T4, and the write back WB of respective execution results is carried out in clock cycle T5.

Similarly, VLIW instruction 3 which is in the next program execution order is fetched and decoded in clock cycles T3 and T4, respectively, operands are accessed respectively from the register file 21 based on the operand codes of the VLIW instruction 3, the load processing LD described in parallel in the VLIW instruction 3 is executed in the execution pipeline 31 by memory access over two clock cycles T5 and T6, and the write back WB of the execution results is carried out in clock cycle T7. In addition, the multiplication processing MUL, the integer processing INT 1 and the integer processing INT 2 described in parallel in the VLIW instruction 3 are executed in parallel in the other three execution pipelines 32 to 34 in clock cycle T5, and the write back WB of respective execution results is carried out in clock cycle T6.

In the VLIW processor described in the above, it is assumed for convenience in description that separate processing units are prepared for the execution pipelines 31 to 34, but it is of course possible to provide an identical processing unit that can programmably execute each designated processing based on the codes of the VLIW instruction.

In the conventional VLIW processor described above, the pipeline execution of a VLIW instruction is performed on the assumption that data dependence among a plurality of processings described in parallel in the VLIW instruction is eliminated by a transformation of the VLIW instruction in the compilation stage in an upstream process, and a plurality of processings described in parallel in one VLIW instruction are pipeline executed in parallel by a plurality of pipelines. As a result, the throughput of the instruction is enhanced, and the program processing performance is enhanced remarkably.

Generally speaking, in a pipeline processing method, instruction execution is not possible if there exists data dependence in the sense that mutual execution results are designated to be operands among instructions under pipeline execution in the execution pipelines. As the simplest method for avoiding data hazard generated by the data dependence among the instructions, there is known a method of applying an NOP execution to or generate a stall in the execution pipelines by adding a function of detecting data hazard in advance. Needless to say, the program execution performance is dropped in proportion to the NOP execution or generation of the stall. For this reason, reduction in the data hazard among instructions is induced by performing high speed execution through addition of a data forwarding function which utilizes in bypassed fashion the execution results in a post-stage as the operands of the processing units in the execution pipelines. Besides, data hazard among instructions is reduced by instruction scheduling during the compilation stage in an upstream process.

Moreover, in this conventional VLIW processor, parallel execution is impossible when a plurality of processings described in parallel in one VLIW instruction are executed in parallel in respective execution pipelines, where there exists mutual data dependence in the sense that execution results are designated as the operands. Accordingly, it is necessary to eliminate the data dependence among a plurality of processings described in parallel in the VLIW instruction, and reduce the data hazard among VLIW instructions, by introducing a VLIW instruction transformation and an instruction scheduling in the compilation stage in an upstream process. In general, occurrence of data hazard among VLIW instructions is more frequent, and the burden at compilation processing for the purpose of enhancing the program processing performance becomes heavier with the increase in the number of processings described in parallel in one VLIW instruction.

### BRIEF SUMMARY OF THE INVENTION

Object of the Invention

It is the object of the present invention to provide a VLIW processor which enhances the program processing performance by executing a plurality of processings, that have a certain data dependence with each other, in parallel at high speed using one VLIW instruction, and reducing data hazard among VLIW instructions.

Summary of the Invention

In the VLIW processor according to the present invention in which a plurality of processings described in parallel in a VLIW instruction are executed in parallel by a plurality of execution pipelines, processings selected and designated from among the plurality of processings are pipeline executed one by one, in each step on a diagonal formed by shifting one step at a time starting with the initial step in the order of parallel arrangement of the plurality of execution pipelines, in the diagonal direction based on the VLIW instruction.

### BRIEF DESCRIPTION OF THE DRAWINGS

The above-mentioned and other objects, features and advantages of this invention will be more apparent by reference to the following detailed description of the invention taken in conjunction with the accompanying drawings, wherein:

FIG. 1 is a block diagram showing a schematic view of the execution part and its circumference in a first embodiment of the VLIW processor according to the present invention;

FIG. 2 is a timing chart showing the pipeline operation of the VLIW processor in FIG. 1;

FIG. 3 is a block diagram showing a schematic view of the execution part and its circumference in a second embodiment of the VLIW processor according to the invention;

FIG. 4 is a timing chart showing the pipeline operation of the VLIW processor in FIG. 3;

FIG. 5 is a block diagram showing a schematic view of the execution part and its circumference in a conventional VLIW processor; and

FIG. 6 is a timing chart showing the pipeline operation of the VLIW processor in FIG. 5.

### DETAILED DESCRIPTION OF THE INVENTION

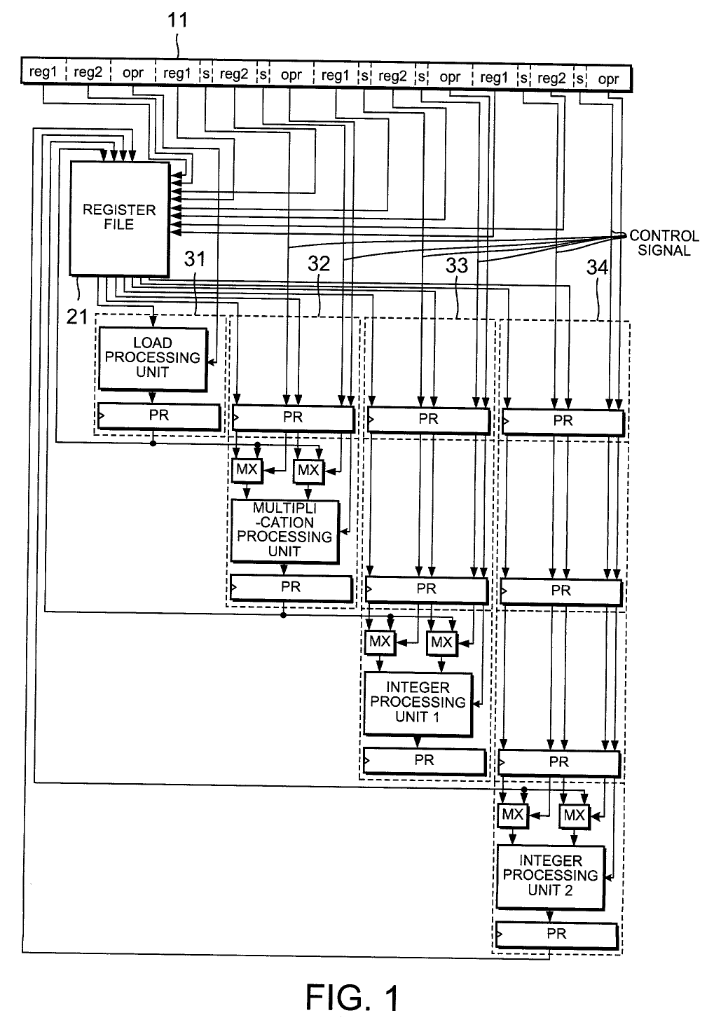

Referring to the drawings, the present invention will be described. FIG. 1 is a block diagram showing a schematic view of the execution part and its circumference in a first embodiment of the VLIW processor according to the present invention.

Referring to FIG. 1, the VLIW processor according to this invention is equipped with an instruction register 11 and a register file 21 in an instruction fetch part and an instruction decode part that fetches and decodes VLIW instruction, respectively. As an execution part, the processor is equipped with four execution pipelines 31 to 34 that execute in parallel four processings described in parallel in the VLIW instruction, and carry out pipeline execution of a processing selected and designated from the plurality of processings one by one in diagonal direction based on the VLIW instruction, in each step on the diagonal shifted by one step starting with an initial step in the order of parallel arrangement.

In addition, each of these four execution pipelines 31 to 34 has one each of the four processing units that operates corresponding to the VLIW instruction, in each step on a diagonal formed by shifting one step at a time starting with the initial step in the order of parallel arrangement of the plurality of processings, and has, in each of the step after the second step on the diagonal, a multiplexer which outputs by switching the execution results of the preceding step on the diagonal, corresponding to the control signals based on the selection bits of the codes of the VLIW instruction, as the operands of the processing units.

Here, reg1, reg2, opr and s indicated in the instruction register 11 represent operand code 1, operand code 2, operation code and selection bit, respectively, of the four processings described in parallel in the VLIW instruction. The abbreviations PR and MX as block names represent a pipeline register and a multiplexer, respectively. In addition, pipeline registers other than the four execution pipelines and other control parts are omitted from the figure.

The execution pipeline 31 is equipped, in the first step, with a load processing unit which inputs accessed operands from the register 21 based on the operand codes of the VLIW instruction fetched in the instruction register 11 and executes the load processing LD based on the operation code of the VLIW instruction, and a pipeline register which pipeline transfers the output of the load processing unit and outputs it as an execution result.

The execution pipeline 32 is equipped, in the first step, with a pipeline register which pipeline transfers the codes of the VLIW instruction fetched by the instruction register 11, control signals based on the selection bits of the codes of the VLIW instruction, and operands accessed from the register file 21 based on the operand codes of the VLIW instruction. In addition, it is equipped, in the second step, with a multiplexer which inputs the operands pipeline transferred from the preceding step and the execution result of the first step of the execution pipeline 31 which is the preceding step on the diagonal and outputs by switching the execution result of the first step of the execution pipeline 31 by means of the control signal pipeline transferred from the preceding step, a multiplication processing unit which executes multiplication processing MUL based on the operation code pipeline transferred from the preceding step, and a pipeline register which pipeline transfers the output of the multiplication processing unit and outputs it as an execution result.

The execution pipeline 33 is equipped, in the first step and the second step, with respective pipeline registers each of which pipeline transfers the codes of the VLIW instruction fetched by the instruction register 11, the control signals based on the selection bits of the codes of the VLIW instruction and the operands accessed from the register file 21 based on the operand codes of the VLIW instruction. In addition, it is equipped, in the third steps, with a multiplexer which inputs the operands pipeline transferred from the preceding step and the execution result of the second step of the execution pipeline 32 which is the preceding step on the diagonal and outputs by switching the execution results of the second step of the execution pipeline 32 by means of the control signals pipeline transferred from the preceding step, an integer processing unit 1 which inputs the output of the multiplexer as the operands and executes an integer processing INT 1 based on the operation code pipeline transferred from the preceding step, and a pipeline register which pipeline transfers the output of the integer processing unit 1 and outputs it as an execution result.

Moreover, the execution pipeline 34 is equipped, in the first stage to the third stage, with respective pipeline registers each of which pipeline transfers the codes of the VLIW instruction fetched by the instruction register 11, control signals based on the selection bits of the codes of the VLIW instruction and the operands accessed from the register file 21 based on the operand codes of the VLIW instruction. In addition, it is equipped, in the fourth step, with a multiplexer which inputs the operands pipeline transferred from the preceding step and the execution result of the third step of the execution pipeline 33 which is the preceding step on the diagonal and outputs by switching the execution result of the third step of the execution pipeline 33 by means of the control signals pipeline transferred from the preceding step, an integer processing unit 2 which inputs the outputs of the multiplexer as the operands and executes the integer processing INT 2 based on the operation code pipeline transferred from the preceding step, and a pipeline register which pipeline transfers the output of the integer processing unit 2 and outputs it as an execution result.

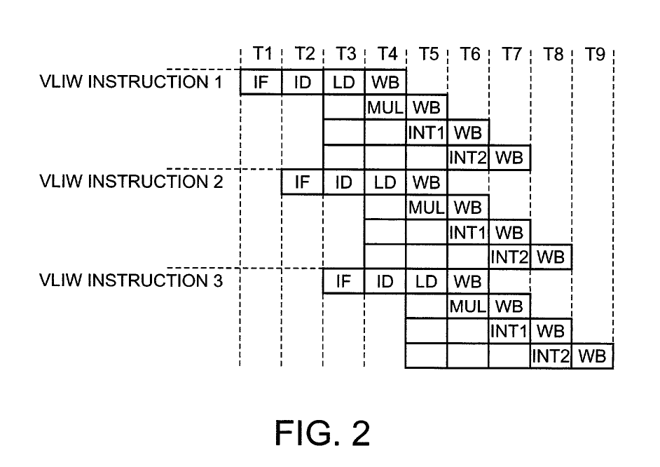

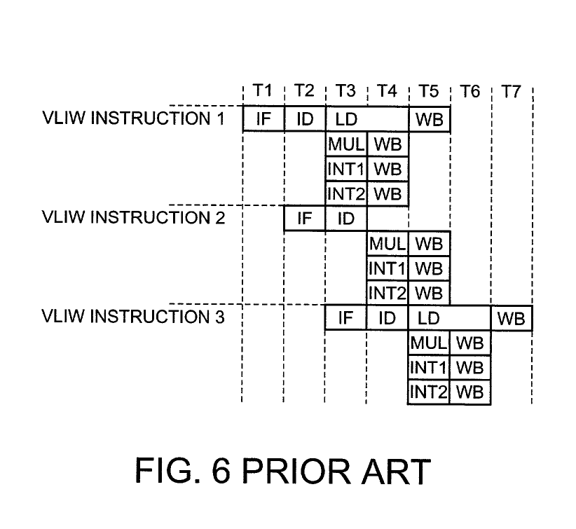

FIG. 2 is a timing chart showing the pipeline operation of the VLIW processor according to the present invention. Analogous to FIG. 6, the VLIW instructions in the program execution order, and the execution pipelines and the clock cycles are represented in the vertical and horizontal directions, and the instruction fetch IF, the load processing LD, the multiplication processing MUL, the integer processing INT 1, the integer processing INT 2 and the write back WB which are the processings in respective pipeline steps of respective VLIW instructions are displayed two-dimensionally.

Next, referring to FIG. 2, the pipeline operation of the VLIW processor according to the invention will be described.

First, a VLIW instruction 1 is fetched and decoded in clock cycles T1 and T2, respectively, operands are accessed respectively from the register file 21 based on decoded operand codes of the VLIW instruction 1, the load processing LD, the multiplication processing MUL, the integer processing INT 1 and the integer processing INT 2 that are described in parallel in the VLIW instruction are executed in parallel in the execution pipelines 31 to 34 sequentially in clock cycles T3, T4, T5 and T6, respectively, and the write back WB of the execution results is carried out in clock cycles T4, T6, T6, and T7, respectively.

In this case, in the execution pipelines 31 to 34, the operation code and the operand codes of the VLIW instruction, the control signals based on the selection bits of the VLIW instruction, and the operands accessed from the register file 21 based on the operand codes are respectively transferred or pipeline transferred to the step on the diagonal, and when the control signals pipeline transferred from the preceding step are active in the step on the diagonal step, the execution results in the preceding step on the diagonal, rather than the operands pipeline transferred from the preceding step by the multiplexer, are respectively output by switching as the operands of the multiplication processing unit, the integer processing unit 1 and the integer unit 2.

As a result, in the stage on the diagonal, the load processing LD, the multiplication processing MUL, the integer processing INT 1 and the integer processing INT 2 that are selected corresponding to the control signals based on the selection bits of the VLIW instruction codes are pipeline executed also in the diagonal direction.

Similarly, VLIW instruction 2 which is in the next program execution order is fetched and decoded in clock cycles T2 and T3, respectively, operands are accessed from the register file 21 based on the operand codes of the VLIW instruction 2, the load processing LD, the multiplication processing MUL, the integer processing INT 1 and the integer processing INT 2 that are described in parallel in the VLIW instruction 2 are executed in parallel sequentially in clock cycles T4, T5, T6 and T7, and the write back WB of respective execution results is carried out respectively in clock cycles T5, T6, T7 and T8. At the same time, in the step on the diagonal, the load processing LD, the multiplication processing MUL, the integer processing INT 1 and the integer processing INT 2 selected sequentially in the order of parallel arrangement corresponding to the control signals based on the selection bits of the VLIW instruction 2 are pipeline executed also in the diagonal direction.

Similarly, VLIW instruction 3 which is in the next program execution order is pipeline executed with a delay of one clock cycle.

As described in the above, in the VLIW processor of this embodiment, the load processing LD, the multiplication processing MUL, the integer processing INT 1 and the integer processing INT 2 described in parallel in the VLIW instruction are respectively executed in parallel in the execution pipelines 31 to 34, and the load processing LD, the multiplication processing MUL, the integer processing INT 1 and the integer processing INT 2 selected based on the selection bits of the VLIW instruction codes can also be pipeline executed in the diagonal direction in a step on the diagonal shifted by one step at a time starting with the initial step in the order of parallel arrangement of the execution pipelines 31 to 34. Accordingly, the load processing LD, the multiplication processing MUL, the integer processing INT 1 and the integer processing INT 2 that have certain data dependence with each other can be executed in parallel at high speed using one VLIW instruction. As a result, data hazard among the VLIW instructions can be reduced, and the program processing performance can be enhanced. Moreover, in the VLIW processor according to this embodiment, it has been assumed for convenience in description that the execution pipelines 31 to 34 are respectively equipped with different processing units, similar to the conventional device. However, it is of course possible to provide identical processing units which can programmably execute the processings that are designated based on the codes of the VLIW instruction, as modification 1 of the VLIW processor according to this embodiment.

Moreover, in the VLIW processor of this embodiment, the invention has been described by assuming that the execution results in steps on the diagonal that are shifted by one step at a time starting with the initial step in the order of parallel arrangement of the execution pipelines 31 to 34 based on the operand codes of the VLIW instruction are respectively written back to the register file 21. However, as a modification 2 of the VLIW processor of this embodiment, it is possible to pipeline transfer the execution results, in the steps on the diagonal shifted by one step at a time starting with the initial step in the order of parallel arrangement of the execution pipelines 31 to 34, to the register file 21, and write back them to the register file 21 at the same timing. With this arrangement, the control circuit of the execution part can be simplified, and the transformation of the VLIW instruction and the instruction scheduling on the compilation stage in the upstream processes can be facilitated.

Furthermore, in the VLIW processor of this embodiment, description has been given by assuming that each step of the four execution pipelines 31 to 34 completes the pipeline operation in one clock cycle. However, as modification 3 of the VLIW processor of this embodiment, it is possible to set that each step of the four execution pipelines 31 to 34 completes the pipeline operation in a number of clock cycles corresponding to the internal pipeline operation of the load processing unit, the multiplication processing unit, the integer processing unit 1 or the integer processing unit 2, respectively.

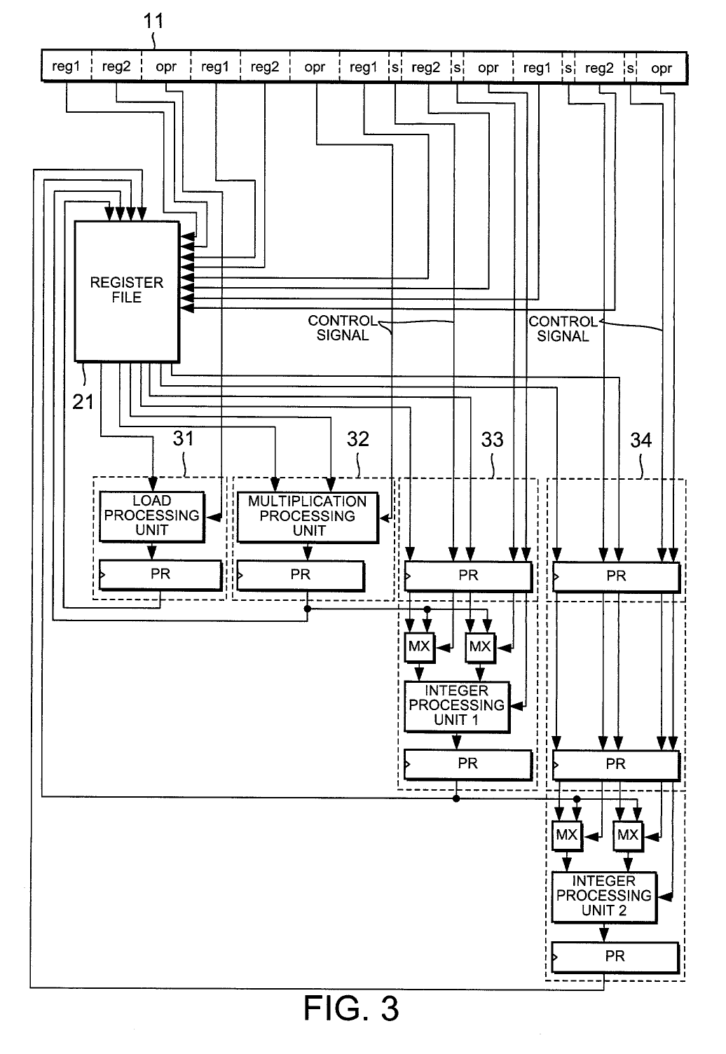

FIG. 3 is a block diagram showing a schematic view of the execution part and its circumference in a second embodiment of the VLIW processor according to this invention.

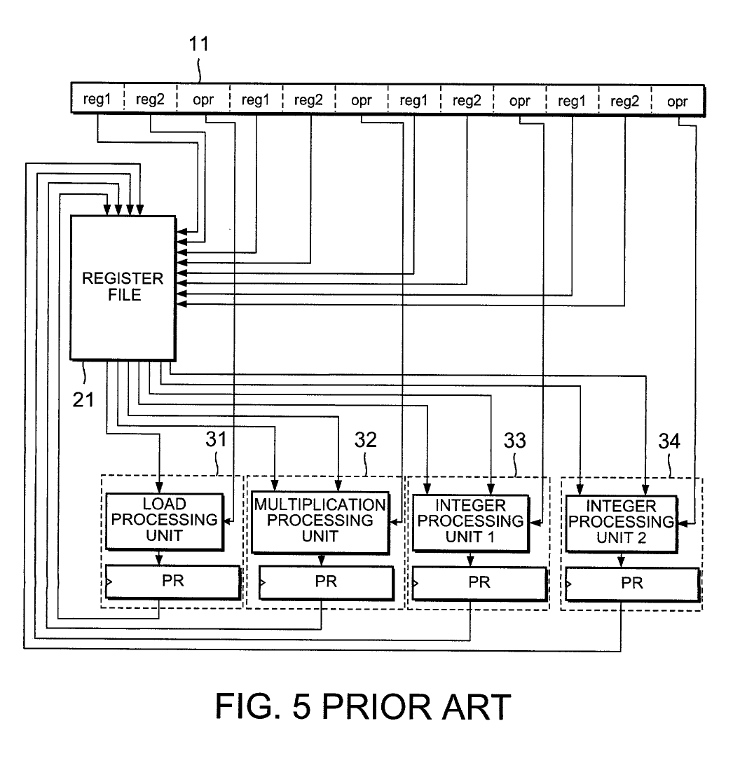

Referring to FIG. 3, it can be seen that the VLIW processor of this embodiment is a combination of the VLIW processors of the prior art and the first embodiment shown in FIG. 5 and FIG. 1, respectively. As an execution part, this processor is equipped with one execution pipeline 31 which pipeline executes in parallel one of the four processings described in parallel in the VLIW instruction, and three execution pipelines 32 to 34 which execute in parallel three out of the four processings described in parallel in the VLIW instruction and pipeline execute in the diagonal direction, one by one, the processings that are selected and designated from among the plurality of processings based on the VLIW instruction in each step on the diagonal shifted by one step at a time starting with the initial step in the order of parallel arrangement.

Here, reg1, reg2, opr and s designated in the instruction register 11 represent the four processings described in parallel in the VLIW instruction, namely, operand code 1, operand code 2, operation code and selection bit, respectively, and the abbreviations for block names PR and MX represent a pipeline register and a multiplexer, respectively. In addition, pipeline registers other than the four execution pipelines 31 to 34, and other control parts are omitted from the drawings.

Analogous to the execution pipeline 31 of the conventional VLIW processor shown in FIG. 5, the execution pipeline 31 of this embodiment is equipped with a load processing unit which inputs operands accessed from the register file 21 based on the operand codes of the VLIW instruction fetched by the instruction register 11 and executes the load processing LD based on the operation code of the VLIW instruction, and a pipeline register which pipeline transfers the output of the processing unit and outputs the execution result.

The execution pipeline 32 is equipped, in the first step, with a multiplication processing unit which inputs the operands accessed from the register file 21 based on the operand codes of the VLIW instruction fetched by the instruction register 11 and executes the multiplication processing MUL based on the operation code of the VLIW instruction, and a pipeline register which pipeline transfers the output of the multiplication processing unit and outputs it as an execution result.

The execution pipeline 33 is equipped, in the first step, with a pipeline register which pipeline transfers the operation code and the operand codes of the VLIW instruction fetched by the instruction register 11, the control signals based on the selection bits of the VLIW instruction codes and the operands accessed from the register file 21 based on the operand codes of the VLIW instruction. In addition, it is equipped, in the second step, with a multiplexer which inputs the operands pipeline transferred from the preceding step and the execution result of the first step of the execution pipeline 32 that is the preceding step on the diagonal and output by switching the execution result of the first step of the execution pipeline 32 by means of the control signals pipeline transferred from the preceding step, an integer processing unit 1 which inputs the outputs of the multiplexers as the operands and executes the integer processing INT 1 based on the operation code pipeline transferred from the preceding step, and a pipeline register which pipeline transfers the output of the integer processing unit 1 and outputs it as an execution result.

Moreover, the execution pipeline 34 is equipped, in the first and second steps, respectively with pipeline registers each of which pipeline transfers the operation code and operand codes of the VLIW instruction fetched by the instruction register 11, the control signals based on the selection bits of the VLIW instruction codes and the operands accessed from the register file 21 based on the operand codes of the VLIW instruction. In addition it is equipped, in the third step, with a multiplexer which inputs the operands pipeline transferred from the preceding step and the execution result of the second step of the execution pipeline 33 that is the preceding step on the diagonal and outputs by switching the execution result of the second step of the execution pipeline 33 by means of the control signals pipeline transferred from the preceding step, and an integer processing unit 2 which inputs the outputs of the multiplexers as operands and executes the integer processing INT 2 based on the operation codes pipeline transferred from the preceding step, and a pipeline register which pipeline transfers the output of the integer processing unit 2 and outputs it as an execution result.

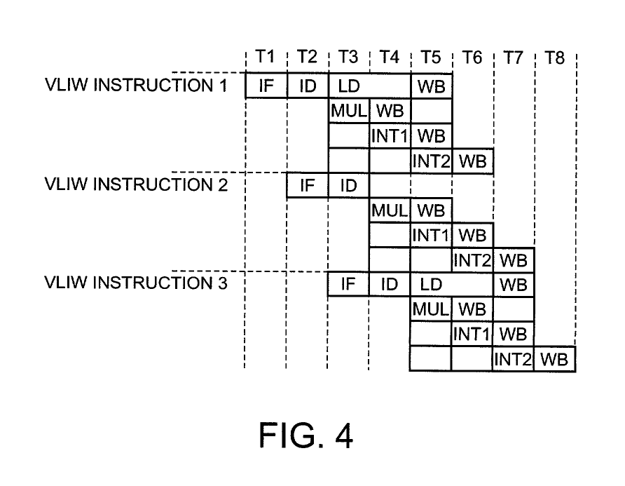

FIG. 4 is a timing chart showing the pipeline operation of the VLIW processor of this embodiment in which the VLIW instructions in the program execution order, and the execution pipelines and clock cycles are represented in the vertical and horizontal directions, respectively, and the instruction fetch IF, the instruction decode ID, the load processing LD, the multiplication processing MUL, the integer processing INT 1, the integer processing INT 2 and the write back WB that are the processings in each of the pipeline step of each VLIW instruction are displayed two-dimensionally.

Next, referring to FIG. 4, the pipeline operation of the VLIW processor according to this embodiment will be described briefly.

First, VLIW instruction 1 is fetched and decoded in clock cycles T1 and T2, respectively, operands are respectively accessed from the register file 21 based on the operand codes of the VLIW instruction 1, the load processing LD described in parallel in the VLIW instruction 1 is executed over clock cycle T3 and T4 in the execution pipeline 31, and write back of the execution result is carried out in clock cycle T5. In addition, the multiplication processing MUL, the integer processing INT 1 and the integer processing INT 2 that are described in parallel in the VLIW instruction are executed in parallel in the three execution pipelines 32 to 34 sequentially in clock cycles T3, T4 and T5, respectively, the write back of respective execution results is carried out in clock cycles T4, T5 and T6, respectively, and thus processings selected and designated from among the plurality of processings corresponding to the control signals based on the selection bits of the codes of the VLIW instruction 1 are pipeline executed in the step on the diagonal also in the diagonal direction.

Similarly, VLIW instruction 2 in the next program execution order is fetched and decoded in clock cycles T2 and T3, respectively, and the operands are accessed respectively from the register file 21 based on the operand codes of the VLIW instruction 2, but the load processing LD that is described in parallel in the VLIW instruction 2 is not executed since the load processing LD described in parallel in the VLIW instruction 1 is under execution in the execution pipeline 31. Moreover, in the other three execution pipelines 32 to 34, the multiplication prpcessing MUL, the integer processing INT 1 and the integer processing INT 2 that are described in parallel in the VLIW instruction 2 are executed in parallel sequentially in clock cycles T4, T5 and T6, respectively, the write back WB of respective execution results is carried out in clock cycles T5, T6 and T7, respectively, and thus processings selected and designated from among the plurality of processings corresponding to the control signals based on the selection bits of the codes of the VLIW instruction 2 are pipeline executed in the step on the diagonal also in the diagonal direction.

Similarly, VLIW instruction 3 which is in the next program execution order is fetched and decoded in clock cycles T3 and T4, respectively, operands are accessed respectively from the register file 21 based on the operand codes of the VLIW instruction 3, the load processing LD described in parallel in the VLIW instruction 3 is executed in the execution pipeline 31 over two clock cycles T5 and T6, and the write back WB of the execution result is carried out in the clock cycle T7. In addition, in the other three execution pipelines 32 to 34, the multiplication processing MUL, the integer processing INT 1 and the integer processing INT 2 described in parallel in the VLIW instruction 3 are executed in parallel sequentially in clock cycles T5, T6 and T7, respectively, the write back WB of the execution results is carried out in clock cycles T6, T7 and T8, respectively, and thus processings selected and designated from among the plurality of processings corresponding to the selection signals based on the selection bits of the codes of the VLIW instruction 3 are pipeline executed in the step on the diagonal also in the diagonal direction.

In the VLIW processor according to this embodiment, the load processing LD described in parallel in the VLIW instruction is executed over two clock cycles for the reason of the memory access, while the multiplication processing MUL, the integer processing INT 1 and the integer processing INT 2 are executed in one clock cycle. Because of this, it is possible to make the execution pipeline 31 which executes the load processing LD to be independent from and parallel to the execution pipelines 32 to 34 of this invention, and carry out the execution of the multiplication processing MUL, the integer processing INT 1 and the integer processing INT 2 which have certain mutual data dependence, in parallel and at high speed using a single VLIW instruction, without deteriorating the throughput of the execution pipelines 32 to 34 of this invention. As a result, the data hazard among the VLIW instructions can be reduced and the program execution performance can be enhanced.

In the above embodiments of the VLIW processor, description has been given assuming that the codes of the VLIW instruction include the field of a plurality of selection bits that respectively select and designate the execution results of the preceding step on the diagonal as the operands of a plurality of processing units. However, there my be presented, as modification 4 of each embodiment of the VLIW processor, a case in which the codes of the VLIW instruction include the field of a plurality of operand codes which designate respectively the operands of a plurality of processing units and, from the designation relation of these operands, suggestively select and designate a plurality of operand codes which designate respectively the execution results in the preceding step on the diagonal as the operands. In this case, the objective can be achieved by collating respective operand codes of the VLIW instruction in the instruction decode part, and generating respective control signals that control the multiplexers in respective pipelines based on the results of the collations.

As has been described in the above, the VLIW processor according to the present invention executes a plurality of processings described in parallel in the VLIW instruction in parallel in a plurality of pipelines, and is capable of pipeline executing, also in the diagonal direction, processings selected and designated from among a plurality of processings based on the VLIW instruction in a step on the diagonal shifted by one step at a time starting with the initial step in the order of parallel arrangement of the plurality of pipelines. Thus, it is possible to execute in parallel and at high speed a plurality of processings that have a certain mutual data dependence by the use of a single VLIW processor.

Furthermore, the data hazard among the VLIW instructions can be reduced, and the program processing performance can be enhanced.

Although the invention has been described with reference to specific embodiments, this description is not meant to be construed in a limiting sense. Various modifications of the disclosed embodiments will become apparent to persons skilled in the art upon reference to the description of the invention. It is therefore contemplated that the appended claims will cover any modifications or embodiments as fall within the true scope of the invention.

What is claimed is:

1. A very long instruction word (VILW) processor for executing in parallel a plurality of processings described in parallel in an instruction of very long word (VLIW instruction) by the use of a plurality of execution pipelines, wherein processings selected and designated from among said plurality of processings are executed in pipeline one by one in a diagonal direction based on said VLIW instruction in each step on the diagonal formed by shifting one step at a time starting with an initial step in the order of parallel arrangement of said plurality of execution pipelines.

2. The VLIW processor as claimed in claim 1, wherein said plurality of execution pipelines are equipped with a plurality of processing units for respectively executing said plurality of processings one unit for each step on said diagonal.

3. The VLIW processor as claimed in claim 2, wherein each step in the second and subsequent steps on said diagonal is equipped with a multiplexer which outputs by switching the execution result in the preceding step of said diagonal corresponding to control signals based on the codes of said VLIW instruction.

4. The VLIW processor as claimed in claim 3, wherein said plurality of execution pipelines transfer in pipeline said codes and said control signals of said VLIW instruction from an instruction fetch part or an instruction decode part that fetches or decodes said VLIW instruction to a step on said diagonal, and transfer in pipeline operands that are accessed based on the codes of said VLIW instruction from a register file in said instruction decode part to the step on said diagonal.

5. The VLIW processor as claimed in claim 4, wherein said plurality of execution pipelines write back respectively the execution results in the steps on said diagonal to said register file based on the codes of said VLIW instruction.

6. The VLIW processor as claimed in claim 4, wherein said plurality of execution pipelines transfer in pipeline respective execution results on the steps of said diagonal to said register file and write them back to said register file at the same timing based on the codes of said VLIW instruction.

7. The VLIW processor as claimed in claim 1, wherein respective steps of said plurality of execution pipelines perform pipeline operation in the number of clock cycles that corresponds to the internal pipeline operations of said plurality of processing units.

8. The VLIW processor as claimed in claim 1, wherein said plurality of execution pipelines perform pipeline execution selectively based on said VLIW instruction in the diagonal direction, one by one in the order of load processing, multiplication processing and integer processing, on respective steps on said diagonal.

9. The VLIW processor as claimed in claim 1, wherein said plurality of execution pipelines perform pipeline execution selectively based on said VLIW instruction in the diagonal direction one by one in the order of the multiplication processing and the integer processing in respective steps on said diagonal, and execute the load processing using an execution pipeline which is independent from and in parallel with said plurality of execution pipelines.

10. The VLIW processor as claimed in cl aim 1, wherein the codes of said VLIW instruction include a field of a plurality of selection bits which select and designate respectively the execution results in the preceding step on said diagonal as the operands of said plurality of processing units.

11. The VLIW processor as claimed in claim 1, wherein the codes of said VLIW instruction include a field of a plurality of operand codes which designate respectively the operands of said plurality of processing units and respectively designate suggestively, from the designation relation of these operands, the execution results in the preceding step on said diagonal as the operands for the processing units.
